(19) United States
(12) Patent Application Publication
(10) Pub. No.: US 2005/0061566 A1
(43) Pub. Date: Mar. 24, 2005

(54) Construction machine and manufacturing method for the same

(75) Inventors: Keiji Yamamoto, Hiroshima-shi (JP); Isao Miyachi, Hiroshima-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KOBELCO CONSTRUCTION MACHINERY CO., LTD, Hiroshima-shi (JP)

(21) Appl. No.: 10/929,600

(22) Filed: Aug. 31, 2004

(30) Foreign Application Priority Data
Sep. 18, 2003 (JP) 2003-326010

(51) Int. Cl. B62D 25/10

(52) U.S. Cl. 180/69.2

(57) ABSTRACT

In a manufacturing method for construction machine according to the present invention, an oil supply port of a fuel tank is disposed near an inner periphery-side guard panel as a standard which is mounted on an innermost periphery side, and in case of mounting the inner periphery-side guard panel, the same guard panel is mounted so that an opening formed in a side wall of the guard panel and the oil supply port are made corresponding to each other, while in case of mounting an outer periphery-side guard panel disposed outside the inner periphery-side guard panel, a depressed portion is formed in a side wall of the outer periphery-side guard panel in accordance with the spacing between the side wall of the outer periphery-side guard panel and the oil supply port, and the outer periphery-side guard panel is mounted so that an opening formed in the depressed portion and the oil supply port are made corresponding to each other. Even in the case where the mounting position of a guard panel changes depending on specifications, the oil supply port can always be positioned near a side wall of the guard panel.

### BACKGROUND OF THE INVENTION

1. Field of the Invention

The present invention relates to a construction machine such as a hydraulic excavator provided with a guard panel and a manufacturing method therefor.

2. Description of the Related Art

A hydraulic excavator is known in which a fuel tank of a reduced height is disposed on a rotating frame of an upper rotating body and an oil supply port is formed in an upper surface of the fuel tank so that it can be seen from a side wall of a guard panel attached to the upper rotating body (see, for example, Japanese Patent Laid Open Publication No. Hei 8-58403).

In case where a cabin is mounted on a rotating frame, a door for opening and closing an entry/exit is usually provided in the cabin. The door is constituted slidably so as to be openable within a rotating radius of the upper rotating body. Therefore, the guard panel is disposed inside the slidable door. Further, the oil supply port is formed so that it can be seen from an opening formed in the side wall of the guard panel disposed inside the door.

On the other hand, in case of a so-called canopy specification hydraulic excavator not provided with a cabin, it is not necessary to ensure such a door sliding space as is required in the cabin specification, and the guard panel is disposed on an outermost periphery side of the upper rotating body in order to make the internal volume of the upper rotating body as large as possible, with the oil supply port being provided in the side wall of the guard panel.

Thus, when it is intended to dispose the oil supply port so as to face the side wall of the guard panel, it has so far been necessary to change the position of the oil supply port according to the position where the guard panel is mounted because the guard panel mounting position is different between the cabin specification and the canopy specification.

### SUMMARY OF THE INVENTION

It is an object of the present invention to provide a construction machine and a manufacturing method for the same wherein, even when a guard panel mounting position changes in a rotating radius direction according to the specification used, a filler opening portion for fueling including a filler neck or an oil supply port can be disposed always in the vicinity of a side wall of the guard panel.

The construction machine according to the present invention has the following basic construction.

This construction machine comprises an upper rotating body having a rotating frame, a fuel tank mounted on the rotating frame and having an oil supply port, and a guard panel secured to the rotating frame to cover an engine and devices on the rotating frame. A depressed portion is formed on a side wall of the guard panel in such a manner that surface of the sidewall is made hollow from a position where the guard panel is mounted toward the oil supply port. An opening is formed in a bottom of the depressed portion so that the oil supply port faces the opening.

In this case, even if the guard panel is replaced by a guard panel not having the depressed portion in the side wall thereof but having a mere opening, the oil supply port can always be disposed near the side wall of the guard panel.

For example, the guard panel mounting position is different between the cabin specification and the canopy specification. In the former case, there is used an inner periphery-side guard panel which is mounted on an innermost periphery side in a rotating radius direction of the upper rotating body, while in the latter case there is used an outer periphery-side guard panel disposed at a more outside position than the inner periphery-side guard panel, and an inward depressed portion is formed in a side wall of the guard panel and an opening is formed in a bottom of the depressed portion.

In this case, the outer periphery-side guard panel can be mounted so that the opening of the depressed portion formed in the side wall of the guard panel and an oil supply port are made corresponding to each other. Thus, even when the guard panel mounting position changes between the cabin specification and the canopy specification, the oil supply port can always be disposed near the side wall of the guard panel.

A manufacturing method for the construction machine according to the present invention comprises the following steps.

In the case where the inner periphery-side guard panel is mounted as a standard so that the oil supply port of the fuel tank described above is positioned near the same guard panel, the same guard panel is mounted so that the opening formed in the guard panel side wall and the oil supply port are made corresponding to each other. On the other hand, in case of mounting the outer periphery-side guard panel in place of the inner periphery-side guard panel, the depressed portion is formed on a side wall of the outer periphery-side guard panel in such a manner that a depth of the depressed portion corresponds to distance between the side wall and the oil supply port, and the outer periphery-side guard panel is mounted so that the opening formed in the bottom of the depressed portion and the oil supply port are made corresponding to each other.

### BRIEF DESCRIPTION OF THE DRAWINGS

FIG. 1 is a plan view of a hydraulic excavator to which a first manufacturing method according to the present invention is applied;

FIG. 2 is a plan view of a principal portion, showing how a guard panel is disposed in a cabin specification;

FIG. 3 is a perspective view of an oil supply port as seen in the direction C in FIG. 2;

FIG. 4 is a perspective view showing the shape of a guard panel in the canopy specification;

FIG. 5 is a plan view showing the disposition of a guard panel to which a second manufacturing method according to the present invention is applied;

FIG. 6 is a vertical sectional view showing the construction of an oil supply port illustrated in FIG. 5, and

FIGS. 7A and 7B are plan views showing oil supply ports in inner and outer periphery-side guard panels, respectively.

### DESCRIPTION OF THE PREFERRED EMBODIMENTS

A first manufacturing method for a construction machine according to the present invention involves mounting a fuel tank on a rotating frame of an upper rotating body of the construction machine and a side wall mounting position of a guard panel for covering an engine and devices or the rotating frame is changed in a rotating radius direction of the upper rotating body in accordance with a mounting, wherein an oil supply port of the fuel tank is disposed near an inner periphery-side guard panel mounted on an innermost periphery side, and in case of mounting the inner periphery-side guard panel, the inner periphery-side guard panel is mounted so that an opening formed in the side wall of the inner periphery-side guard panel and the oil supply port are made corresponding to each other, while in case of mounting an outer periphery-side guard panel disposed outside the inner periphery-side guard panel, a depressed portion is formed inwards in the side wall of the outer periphery-side guard panel in accordance with the spacing between the side wall of the outer periphery-side guard panel and the oil supply port disposed with the inner periphery-side guard panel as a reference, and the outer periphery-side guard panel is mounted so that an opening formed in a bottom of the depressed portion and the oil supply port are made corresponding to each other.

Even in the case where the mounting position of a guard panel changes depending on whether the construction machine is the cabin specification or the canopy specification, the oil supply port can be always disposed near the side wall of the guard panel.

In a second manufacturing method for a construction machine according to the present invention, in case of mounting an inner periphery-side guard panel, the inner periphery-side guard panel is mounted so that an opening formed in a side wall of the inner periphery-side guard panel and an oil supply port of a fuel tank are made corresponding to each other, while in case of mounting an outer periphery-side guard panel disposed outside the inner periphery-side guard panel, an extension pipe, as feed oil pipe or oil fill tube is provided from the fuel tank toward the outer periphery-side guard panel, the fuel supply port is provided at a front end of the extension pipe, and the outer periphery-side guard panel is mounted so that an opening formed in the side wall of the outer periphery-side guard panel and the oil supply port are made corresponding to each other.

In this case, by only adjusting the length of the extension pipe it is possible to cope with a change of the guard panel mounting position.

Regarding the guard panels whose mounting positions differ depending on mounting specifications as described above, a cabin specification guard panel, which is disposed inside the rotating radius by a distance corresponding to a moving space of a door adapted to slide open and close along the guard panel, is shown as the inner periphery-side guard panel, while a canopy specification guard panel is shown as the outer periphery-side guard panel.

The present invention will be described in detail hereinunder by way of embodiments thereof illustrated in the drawings.

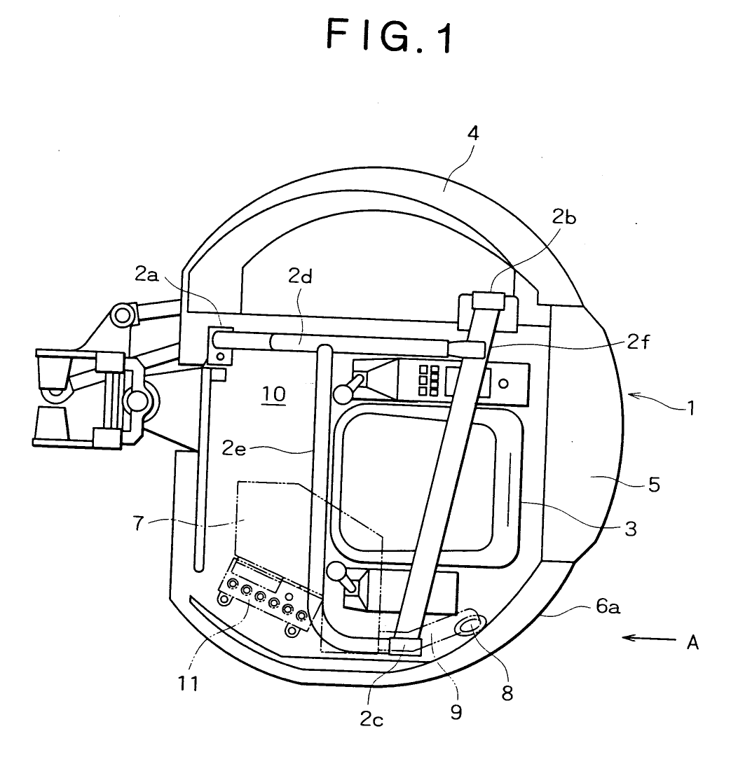

FIGS. 1 to 4 illustrate a first manufacturing method according to the present invention.

The manufacturing method according to the present invention is applicable in common to hydraulic excavators both canopy specification and cabin specification. Reference will first be made to the construction of a canopy specification hydraulic excavator.

FIG. 1 is a plan view of an upper rotating body 1 which is rotatably mounted on a lower traveling body in a canopy specification hydraulic excavator. For simplification of explanation, a front attachment attached to a front portion of the upper rotating body 1 is removed in FIG. 1.

Canopy supports 2a to 2c for supporting a canopy (roof) (not shown) are provided on a rotating frame of the upper rotating body 1. Numerals 2d to 2f denote frames which connect the supports 2a to 2c in the horizontal direction. Numeral 3 denotes an operator's seat, with the canopy disposed thereabove.

Numeral 4 denotes a guard panel disposed on the right side of the operator's seat. Such as a hydraulic oil tank and control valves are accommodated in the interior of the guard panel.

Numeral 5 denotes a counterweight mounted to a rear portion of the upper rotating body.

Numeral 6a denotes a guard panel (outer periphery-side guard panel) disposed on a left rear side of the operator's seat 3. An oil supply port 8 of a fuel tank (indicated with a dash-double dot line in the figure) is disposed in a side wall of the guard panel 6a. The guard panel 6a is mounted on an outermost periphery side of the upper rotating body 1.

The oil supply port 8 is connected to the fuel tank 7 through a pipe 9. The fuel tank 7 is accommodated in a space formed between the rotating frame and a floor panel 10 (the rotating frame is disposed under the floor panel 10). That is, the fuel tank 7 used in this embodiment is thin so that a certain volume can be ensured even in a narrow space. As an example, the fuel tank 7 is formed by molding of resin.

Like the fuel tank 7, the pipe 9 is also formed by molding of resin. Numeral 11 in the figure denotes a battery.

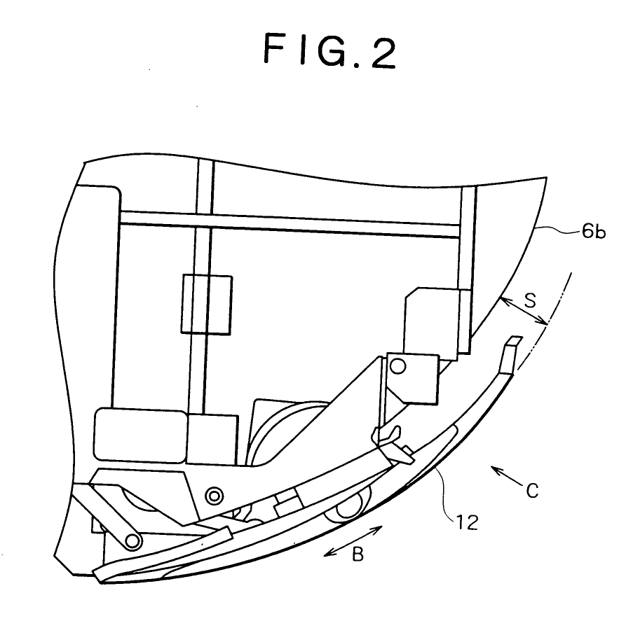

Next, a principal portion of a cabin specification hydraulic excavator is shown in FIG. 2.

FIG. 2 illustrates the disposition of the oil supply port 8 on a larger scale.

In case where a cabin is mounted, a door 12 for opening and closing an entry/exit of the cabin is adapted to slide in arrow B directions along an outer wall of a guard panel (inner periphery-side guard panel) 6b.

In order that the door adapted to be openable on an outermost periphery side by a link drive mechanism (not shown) can be positioned within a rotating radius, the guard panel 6b is mounted at a position shifted toward the center of the upper rotating body 1 by a distance S from the door 12.

In the following description, when the canopy specification guard panel 6a and the cabin specification guard panel 6b are to be generically termed, the guard panel 6 is a generic term for them.

Thus, the mounting position of the guard panel 6 differs between the canopy specification and the cabin specification.

Under such circumstances it is an object of the present invention to make the disposition of the fuel tank 7 and that of the oil supply port 8 common to both canopy specification and cabin specification.

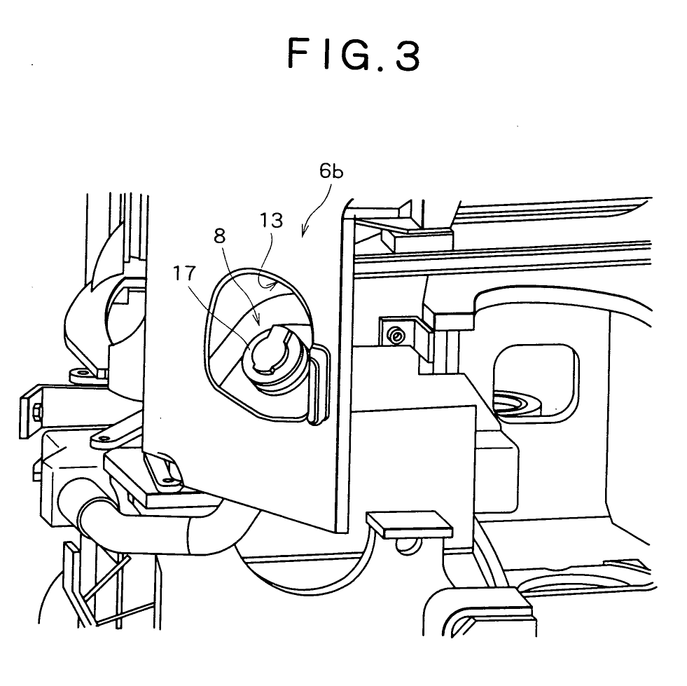

In the cabin specification hydraulic excavator, as shown in the side view of FIG. 3, if an opening 13 is formed in a side wall of the guard panel 6b in a corresponding relation to the oil supply port 8, the oil supply port 8 can face the opening 13. In FIG. 3, the oil supply port 8 is seen in the direction of arrow C in FIG. 2, with the door 12 removed.

However, if the oil supply port 8 is positioned on the basis of cabin specification, the oil supply port 8 is approached the central side of the upper rotating body 1. In the canopy specification, therefore, the guard panel 6a shown in FIG. 1 and the oil supply port 8 are spaced apart from each other. Even if an opening is formed in the guard panel 6a in this state, an oil supply gun as oil supply means does not reach the oil supply port 8.

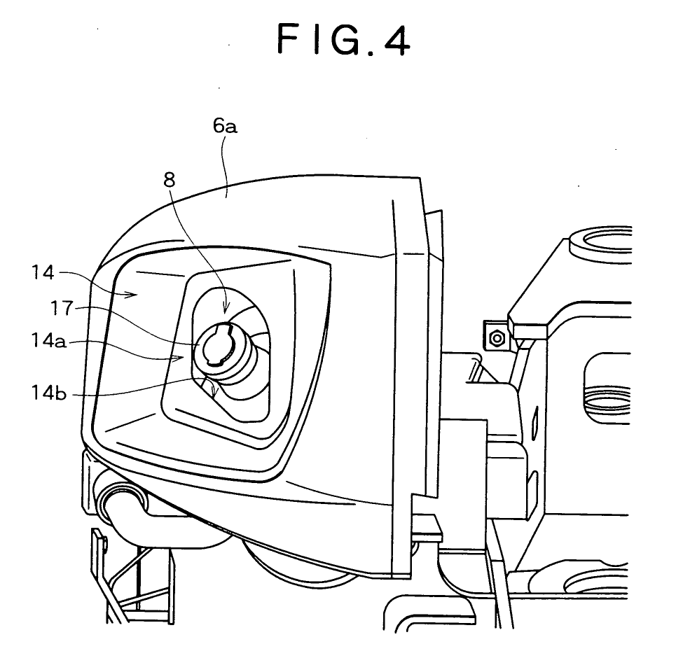

In the canopy specification, as shown in FIG. 4, a depressed portion 14 is formed in a side wall of the guard panel 6a toward the inside of the machine body at a position corresponding to the oil supply port 8.

The depressed portion 14 is formed in a concave shape having a sufficient width in all of upper, lower and right, left sides and having sufficient depth so as to avoid contact of an oil supply gun (not shown) with the guard panel 6a no matter in what direction the oil supply gun may access. The peripheral edge of the depressed portion 14 when seen from a side face is formed in a rectangular shape, provided the peripheral edge shape of the depressed portion 14 is not limited to such a rectangular shape.

An opening 14b is formed in a bottom 14a of the depressed portion 14. The oil supply port 8 can be seen through the opening 14b.

As to the cabin specification hydraulic excavator, the opening 13 is formed in the guard panel 6a as described above and as shown in FIG. 3, whereby a fuel cap 17 can be seen. As to the canopy specification hydraulic excavator, as shown in FIG. 4, the depressed portion 14 is formed in the guard panel 6a and the opening 14b is formed in the bottom of the depressed portion 14, whereby the fuel cap 17 can be seen. Thus, the disposition of the oil supply port 8 can be made common to both cabin specification and canopy specification. As a result, even in case where a resin molded product of a high manufacturing cost is adopted as the pipe 9 (see FIG. 1), it is not necessary to use two types of pipes 9 for the cabin specification and the canopy specification, but one type of the pipe 9 suffices, so that it is possible to attain the reduction of cost.

In this case, since the depressed portion 14 is formed on the side wall of the guard panel 6a toward the oil supply port 8 which is positioned away from the side wall mounting position of the guard panel 6a, the oil supply gun can be approximated to the oil supply port 8 in an arbitrary direction. Also when supplying oil to the tank, the supply of oil can be done easily because the surrounding portion of the oil supply port is open and not in contact with the tank.

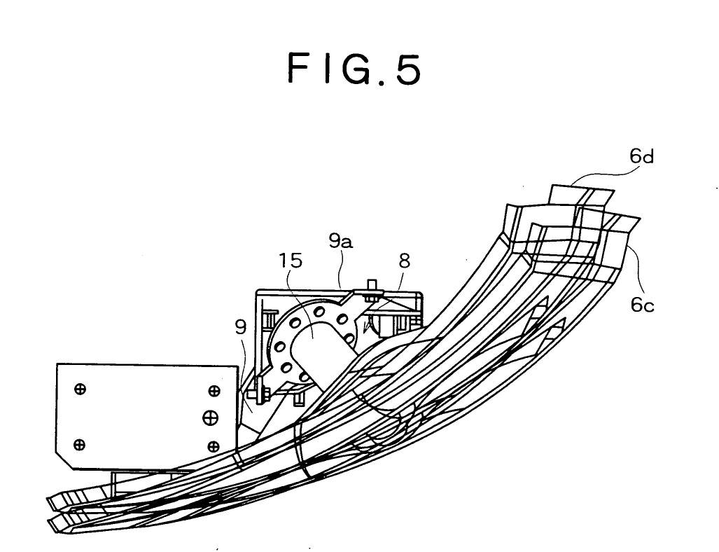

Next, the second manufacturing method according to the present invention will be described below with reference to FIGS. 5 to 7B.

FIG. 5 shows a case where the disposition of a guard panel changes depending on class (tonnage) even in the same canopy specification for example.

In the same figure, numeral 6c represents a mounting position of a 4-ton class guard panel (outer periphery-side guard panel) and numeral 6d represents a 3-ton class guard panel (inner periphery-side guard panel).

Also in such a case there arises the necessity of making an oil supply port corresponding to the disposition of each guard panel.

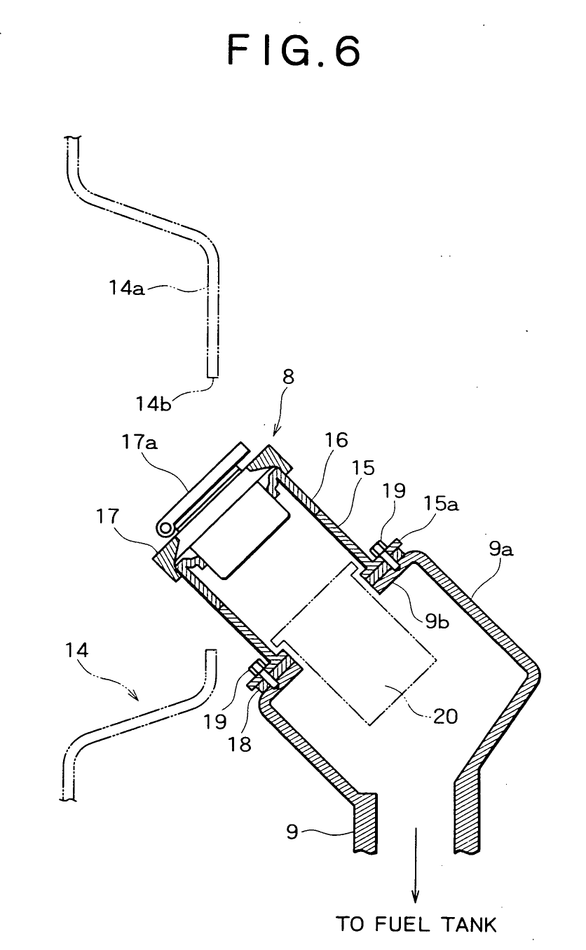

To meet this requirement, an extension pipe 15 as feed oil pipe or oil fill tube is connected to an oil supply port-side end portion 9a of a pipe 9 communicating with the fuel tank 7, and a filler neck 16 is connected to a front end of the extension pipe 15 (see FIG. 6).

An oil supply port 8 is positioned near the guard panel 6c or 6d by adjusting the length of the extension pipe 15.

FIG. 6 shows the construction of the oil supply port 8.

In the same figure, the filler neck 16 is connected through the extension pipe 15 to the oil supply port-side end portion 9a which is box-shaped, and a fuel cap 17 for opening and closing the oil supply port is fitted on the filler neck 16.

The cap 17 is of a key lock type. That is, if a cover 17a of the cap 17 is opened and a key (not shown) is inserted into a key hole and is turned 90° rightwards, it is possible to remove the cap 17. On the other hand, by turning the key 90° leftwards in the fitted state of the cap 17, it is possible to fasten a lock.

The filler neck 16 and the extension pipe 15 are fixed together by welding. A flange portion 15a formed at a skirt portion of the extension pipe 15 is in contact with a sealing member 18 against an annular seat portion 9b formed along an open edge of the oil supply port-side end portion 9a. The flange portion 15a and the annular seat portion 9b are fastened and united together by threaded engagement therewith of screws 19. Numeral 20 in the figure denotes a filter disposed within the oil supply port-side end portion 9a.

Thus, even if the mounting positions of the guard panels 6c and 6d are different from each other, openings formed in the guard panels 6c and 6d and the fuel cap 17 can be maintained in a constant relation by adjusting the length of the extension pipe 15 and thereafter connecting the filler neck 16 thereto.

If the skirt portion of the extension pipe 15 is cut obliquely relative to the shaft of the pipe and the flange portion 15a is fixed to the annular seat portion 9b of the oil supply port-side end portion 9a, it is possible to change the angle of the filler neck 15 projecting from the oil supply port-side end portion 9a. Consequently, even in case where an opening position of a guard panel changes vertically or transversely, it is possible to make the fuel cap 17 corresponding to the opening positively.

Thus, since the extension pipe 15 is disposed between the filler neck 16 of the oil supply port 8 and the fuel tank 7, at least one of its length and mounting angle relative to the fuel tank 7 can be adjusted in accordance with a variation of side wall mounting positions of the guard panels 6c and 6d.

Also in this case, even if the opening position of the guard panel 6c (6d) changes, it is possible to surely make the opening and the oil supply port 8 correspond or face to each other.

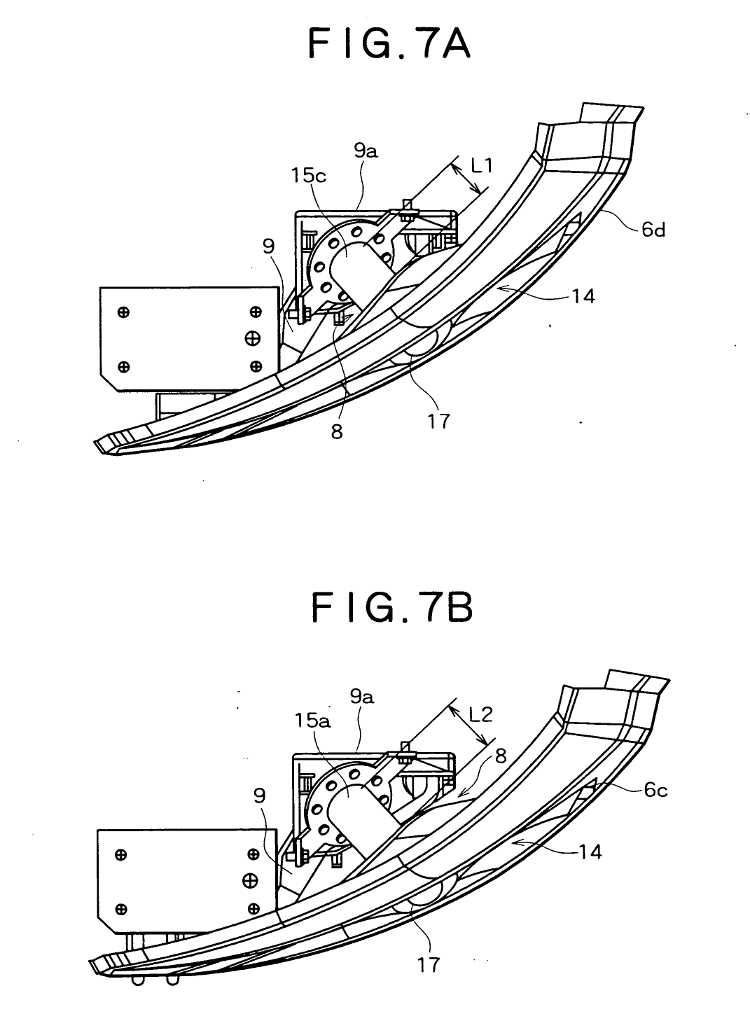

FIGS. 7A and 7B separately illustrate the disposition of the oil supply port in case of mounting the guard panel 6d and that in case of mounting the guard panel 6c.

Given that the length of the extension pipe 15c in case of mounting the guard panel 6d in FIG. 7A is L1 and the length of the extension pipe 15d in case of mounting the guard panel 6c in FIG. 7B is L2, the value S of L2-L1 corresponds to an allowance for adjustment obtained by the outer periphery-side disposition of the guard panel 6c.

Although the invention has been described with reference to the preferred embodiments in the attached figures, it is noted that equivalents may be employed and substitutions made herein without departing from the scope of the invention as recited in the claims.

1. A construction machine comprising:
an upper rotating body having a rotating frame;
a fuel tank mounted on said rotating frame, said fuel tank having a filler opening portion; and
a guard panel secured to said rotating frame adapted to cover an engine and devices on said rotating frame,
wherein a depressed portion is formed on a side wall of said guard panel in such a manner that said depressed portion extends in a direction from a position where said guard panel is mounted toward said filter opening portion, and an opening is formed in a bottom of said depressed portion so that said filler opening portion faces said opening.

2. The construction machine according to claim 1, wherein said guard panel is a canopy specification guard panel.

3. The construction machine according to claim 1, wherein said guard panel is an outer periphery-side guard panel mounted outside an inner periphery-side guard panel which is mounted on an innermost periphery side in a rotating radius direction of said upper rotating body.

4. The construction machine according to claim 1, further comprising:
an extension pipe extending from said fuel tank toward said guard panel.

5. A manufacturing method for construction machine, comprising the steps of:
mounting the fuel tank on said rotating frame in such a manner that the filler opening portion of the fuel tank is disposed in the vicinity of said inner periphery-side guard panel of claim 3;
in case of mounting said inner periphery-side guard panel, mounting the inner periphery-side guard panel so that an opening formed in the inner periphery-side guard panel and said filler opening portion face to each other; and
in case of mounting said outer periphery-side guard panel of claim 3 in place of said inner periphery-side guard panel, forming the depressed portion on a side wall of said outer periphery-side guard panel in such a manner that a depth of the depressed portion corresponds to distance between the side wall of the outer periphery-side guard panel and said filler opening portion, and mounting said outer periphery-side guard panel so that the opening formed in the bottom of said depressed portion and said filler opening portion face to each other.

6. A manufacturing method for construction machine, comprising the steps of:
in case of mounting said inner periphery-side guard panel of claim 3, mounting the inner periphery-side guard panel so that an opening formed in a side wall of the inner periphery-side guard panel and the filler opening portion of said fuel tank of claim 3 face to each other; and
in case of mounting said outer periphery-side guard panel of claim 3 in place of said inner periphery-side guard panel, disposing an extension pipe so as to extend from said fuel tank toward said outer periphery-side guard panel, providing the filler opening portion at a front end of said extension pipe, and mounting said outer periphery-side guard panel so that the opening formed in a side wall of the outer periphery-side guard panel and said filler opening portion face to each other.

7. The manufacturing method for construction machine according to claim 6, wherein said extension pipe is disposed between a filler neck of said filler opening portion and said fuel tank, and either length of said extension pipe or a mounting angle thereof relative to the fuel tank is adjusted in accordance with a variation of mounting positions of said guard panel.

8. The manufacturing method for construction machine according to claim 5, wherein said inner periphery-side guard panel is a cabin specification guard panel which is disposed inside said rotating radius by a distance corresponding to a moving space of a door adapted to slide along the guard panel, and wherein said outer periphery-side guard panel is a canopy specification guard panel.
